(19) United States
(12) Patent Application Publication
(10) Pub. No.: US 2014/0113542 A1
(43) Pub. Date: Apr. 24, 2014

(54) Method and Apparatus for Solar Fan Controller

(71) Applicants: Geoffrey Foreman, Incline Village, NV (US); Robert Buckley, Incline Village, NV (US)

(72) Inventors: Geoffrey Foreman, Incline Village, NV (US); Robert Buckley, Incline Village, NV (US)

(73) Assignee: U.S. Sunlight Corp., Reno, NV (US)

(21) Appl. No.: 13/462,571

(22) Filed: May 2, 2012

(51) Int. Cl. F24F 11/053; G05D 23/19; F24F 7/007

(52) U.S. Cl. 454/239; 236/49.3; 236/51

(57) ABSTRACT

A method and apparatus for solar fan controller have been disclosed. In one version a solar fan controller (SFC) uses inputs about temperature, humidity, weather, and fan status to control a fan.

### RELATED APPLICATION

The present application for patent is related to U.S. Patent Application No. 61/364,967 entitled “Method and Apparatus for Attic Fan Power Controller with Remote Control” filed Jul. 16, 2010, pending, and is hereby incorporated herein by reference. The present application for patent is related to U.S. patent application Ser. No. 13/184,334 entitled “Method and Apparatus for Attic Fan Power Controller with Remote Control” filed Jul. 15, 2011, pending, and is hereby incorporated herein by reference.

### FIELD OF THE INVENTION

The present invention pertains to controllers. More particularly, the present invention relates to a method and apparatus for solar fan controller (SFC).

### BACKGROUND OF THE INVENTION

Fans are used to move air and for many situations provide some degree of assistance in cooling humans and/or structures. A source of power that is becoming more favored is solar. However, due to the limited power provided by solar, traditional attic fans may not be able to run when needed, for example, in cloudy conditions, or at night. This presents a problem.

Additionally, an attic fan may run when not needed. This presents a problem. Additionally, operating without additional inputs such as lowest energy operating costs, most efficient use of energy, current and future weather conditions, etc. are likely to lead to more expensive operation. This presents a technical problem for which a technical solution is needed.

### BRIEF DESCRIPTION OF THE DRAWINGS

The invention is illustrated by way of example and not limitation in the figures of the accompanying drawings.

FIG. 1 illustrates a network environment from which the techniques described may be accessed and/or controlled.

FIG. 2 is a block diagram of a computer system which some embodiments of the invention may employ parts of in conjunction with required specialized hardware.

FIG. 3 illustrates one embodiment of the invention showing various parts.

FIG. 4 illustrates various embodiments of the invention showing optional features.

FIG. 5 illustrates various embodiments of the invention.

FIG. 6 illustrates various embodiments of the invention.

FIGS. 7 and 8 illustrate various embodiments of the invention.

### DETAILED DESCRIPTION

A method and apparatus for solar fan controller is disclosed.

In one embodiment of the invention, a solar fan controller (SFC) may be used to control a fan, for example, but not limited to a fan powered by solar power, for example, but not limited to, a solar panel in proximity to the fan.

In one embodiment of the invention, a solar fan controller (SFC) may be used to control a fan, for example, but not limited to a fan powered by electrical power, for example, but not limited to, electrical power from a home interior.

In one embodiment of the invention, a solar fan controller (SFC) may be used to control a fan, for example, but not limited to a fan powered by solar power and/or electrical power as the need arises, for example, but not limited to, electrical power from a home interior via a wall wart or a solar panel.

In one embodiment of the invention, a solar fan controller (SFC) may be used to control an attic fan.

In one embodiment of the invention the solar fan controller (SFC) enables an attic fan to run on both solar power and house electricity (power line) and performs seamless integration of both power sources for continuous operation.

In one embodiment of the invention the solar fan controller is an intelligent power distributor equipped with temperature and humidity sensors as well as wireless capabilities allowing for such things as, but not limited to, remote control, Internet access and reporting.

In one embodiment of the invention the solar fan controller can be custom-set for various weather conditions.

In one embodiment of the invention wireless technology, such as but not limited to, WiFi (also known as Wi-Fi) capability is embedded and the solar fan controller contains logic allowing access to a home's wireless Internet access.

In one embodiment of the invention featuring wireless technology, the solar fan controller has the capability to include, for example, but not limited to, remote access to the solar fan controller, controlling one or more attic fans, sensing and retrieving attic status, and sensing and retrieving attic conditions. For example, a user may obtain operating information, such as, but not limited to, all current operating conditions via the Internet on a mobile wireless device or any computer with Internet access.

In one embodiment of the invention, operating information may include, but is not limited to attic temperature, attic humidity, fan operating status, such as fan on using solar power, fan on using house power, fan off or fan intermittent status (e.g. fan cycles 8 minutes on and 22 minutes off while on house power, etc.), fan off—solar not available and house power is not connected, fan failure—a diagnostic tool to indicate service is required, etc.

In one embodiment of the invention remote collection of attic environment data is possible. The solar fan controller with wireless capability can access the Internet and transmit data to a central data collection location. This data will be useful to builders, roofing, and insulation materials manufacture's to improve the performance of their products. Information collected may include, but is not limited to, peak, average, and low attic temperature; peak, average, and low attic humidity; attic atmospheric pressure; outside atmospheric pressure; home interior atmospheric pressure; etc.

In one embodiment of the invention wireless capability allows an attic fan to be integrated into a smart thermostat that can make intelligent decisions on the most economical method to achieve desired interior climate conditions. As an example, the thermostat can monitor outside ambient temperature and humidity, attic temperature and humidity, and interior temperature and humidity to determine how best to operate the furnace, air conditioner, ceiling fans, whole house fans, and attic fans.

In one embodiment of the invention atmospheric pressure information is used in the solar fan controller to determine if the attic pressure is lower than the interior pressure of the home. In such a condition, a fan can be ordered to cease operation to prevent conditioned air in the home from flowing into the attic because such air flow results in a reduction of energy efficiency.

In one embodiment of the invention the solar fan controller is equipped with a smoke sensor (e.g. ionization and/or photoelectric) to shut down the fan in the event of a wildfire to prevent the possibility of hot embers being sucked into the attic. If a fire were to exist in the attic or in the interior of the home it can also shut down the fan to prevent adding oxygen to the fire.

In one embodiment of the invention, as an alternative to the smoke detector, the solar fan controller is equipped with an optical flame sensor to detect the presence of an active fire in the attic and shut down the fan. This would avoid a nuisance shutdown associated with smoke from a neighbor's chimney or a brush pile in a controlled burn.

In one embodiment of the invention the solar fan controller can be controlled by a remote control. In one embodiment of the invention the remote control can have a “turbo” button. The purpose of the turbo button is to override temporarily a present duty cycle (e.g. 8 minutes on/22 minutes off cycle) and allow the fan to run on a continuous basis, for example, until the sun becomes available again and the fan switches to solar power. This may be useful on extremely hot evenings when the customer desires maximum cooling from the fan or when a whole house fan is installed and is rapidly pulling air from the house pushing it into the attic. A whole house fan will work much more efficiently if the attic fan is exhausting air as fast as the whole house fan is pushing it into the attic. In one embodiment of the invention the turbo button would also have the capability to operate the fan at a higher revolutions per minute (RPM) and higher flow rate for a brief period of time. In one embodiment of the invention when operating on house power, the alternating current (AC) to direct current (DC) adapter can provide 15V (volts) or 24V electricity to the motor when the solar panel is limited to a maximum of 12V. The effect is to increase the power available to the fan blade, thereby increasing the air flow rate.

In one embodiment of the invention, the solar fan controller can force the attic fan to operate when a compatible whole house fan is operating in order to have the whole house fan operate efficiently and avoid over pressurizing the attic. Whole house fans pull air from the interior of the home and exhaust it into the attic. Cooler ambient air is then brought into the home interior through an open window and/or door. The solar fan controller can be utilized to make intelligent decisions about whether the ambient temperature is sufficiently low to achieve the desired home interior temperature.

In one embodiment of the invention the solar fan controller with wireless capability and access to the Internet will have access to information such as, but not limited to, current weather conditions available via the Internet and provides the basic functions of a local weather station. This can include a weather forecast, current outside temperature, and weather warnings. This information can be used by the solar fan controller to increase functionality (over dumb operation i.e. without this information) and to optimize the cost of achieving the comfort level in the home as well as protection of the structure from excessive heat and moisture.

In one embodiment of the invention the solar fan controller will help optimize the solar panel orientation towards the sun as the sun moves through its path from sunrise until sunset. The solar panel, installed on a track is equipped with a small motor so that the panel will slowly move along the track and maintain a substantially perpendicular orientation to the sun's rays path. In one embodiment of the invention the solar fan controller contains a timer that can be set for summertime or wintertime and set for a particular latitude which in turn will control the solar panels' path from sunrise until sunset based on the predicted hours of available sunlight for the input conditions. At sunset or early in the morning, the solar panel(s) is repositioned to the sunrise orientation. In one embodiment of the invention the solar fan controller is connected to AC power or battery supplied DC power for the repositioning of the panel(s).

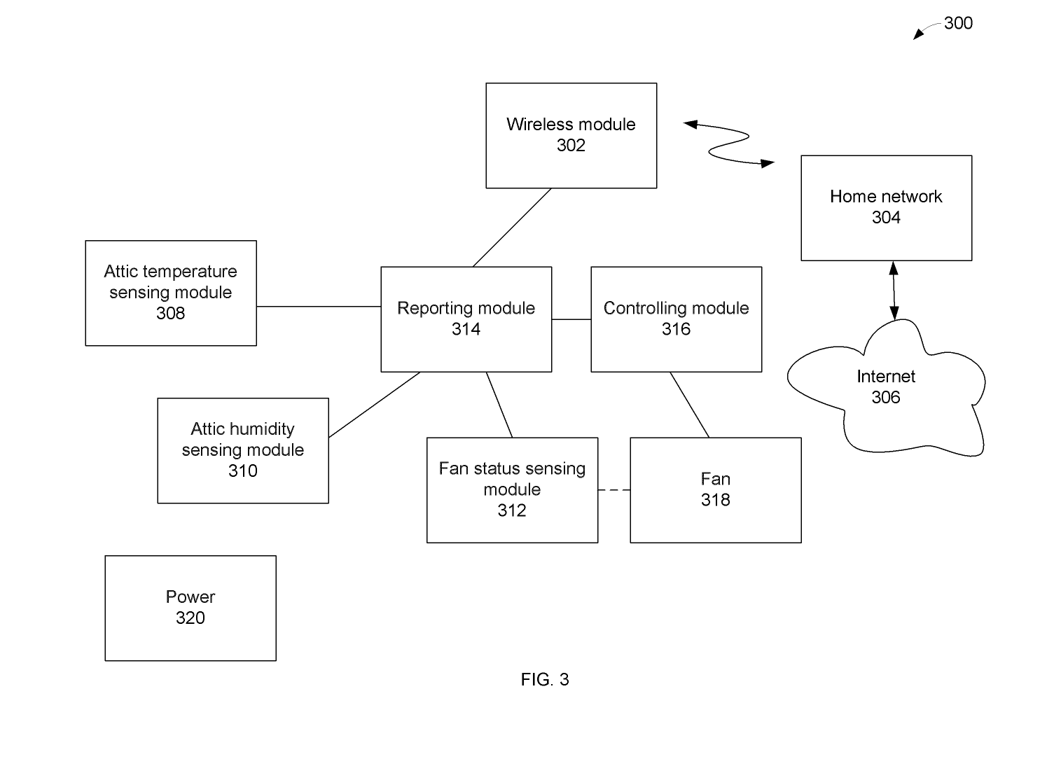

FIG. 3 illustrates, generally at 300, one embodiment of the invention showing various parts. 302 is a wireless module that can interface wirelessly with a home network 304, the home network 304 having access to the Internet 306. In this way the wireless module may send and receive information and control. At 314 is a reporting module that is connected to wireless module 302. Reporting module communicates with attic temperature sensing module 308, attic humidity sensing module 310, fan status sensing module 312, and controlling module 316. Fan status sensing module 312 may be in direct communication with fan 318 to sense status, such as, but not limited to voltage, current, etc., or may be in proximity to fan 318 to sense status, such as, but not limited to RPM via, for example, an optical method. This direct/indirect sensing is indicated by the dashed line between fan status sensing module 312 and fan 318. Fan 318 is in communication with controlling module 316. Power 320 supplies power to the modules and fan.

In one embodiment of the invention, for example with parts illustrated in FIG. 3, without anything more than the controlling module 316, the fan 318, the reporting module 314, the wireless module 302, the attic temperature sensing module 308, and power 320, the solar fan controller may operate.

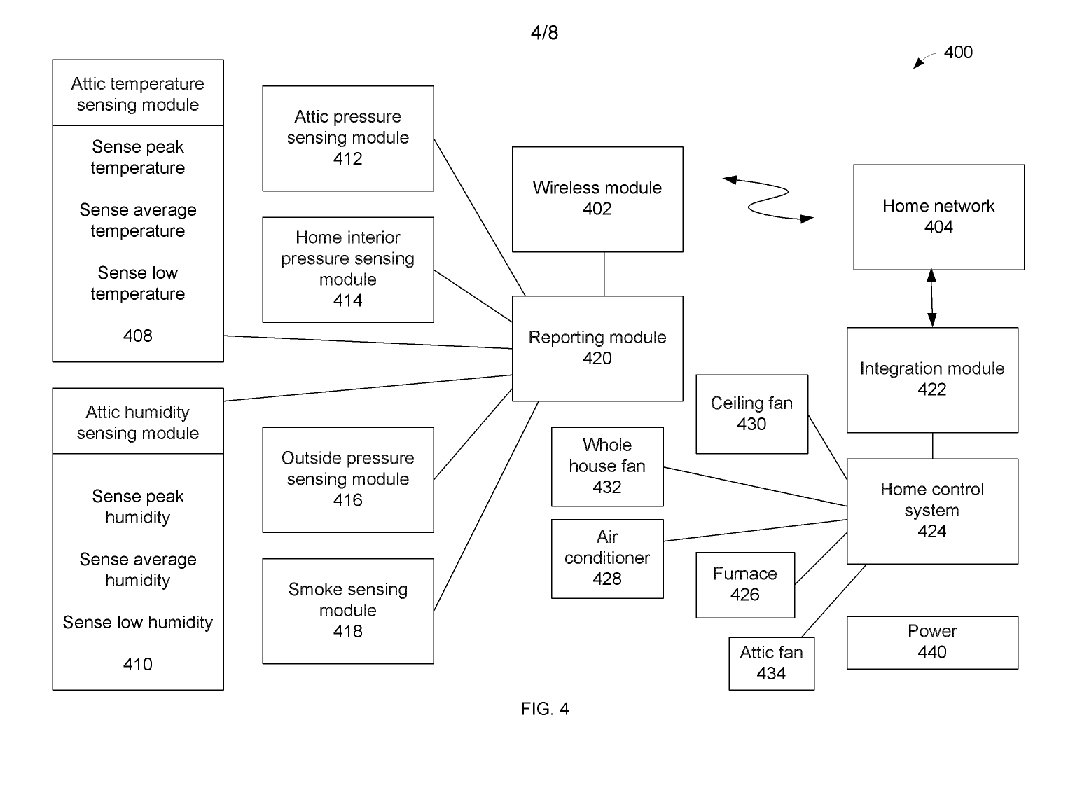

FIG. 4 illustrates, generally at 400, various embodiments of the invention showing optional features. For example, at 408 the attic temperature sensing module can sense a peak attic temperature, and/or an average attic temperature, and/or and low attic temperature. Likewise at 410 attic humidity sensing module can sense a peak attic humidity, and/or an average attic humidity, and/or and low attic humidity. Optionally, one embodiment of the invention can have an attic pressure sensing module 412. Optionally, one embodiment of the invention can have a home interior pressure sensing module 414. Optionally, one embodiment of the invention can have an outside pressure sensing module 416. Optionally, one embodiment of the invention can have an smoke sensing module 418. These optional modules are powered by power 440 and are in operative communication with reporting module 420 in communication with wireless module 402.

FIG. 4 illustrates, generally at 400, various embodiments of the invention showing optional features. For example, in one embodiment of the invention at 422 is an integration module that is in operative communication with a home control system 424 that may control and/or be in receipt of information from such things as ceiling fan 430, whole house fan 432, air conditioner 428, furnace 426, and attic fan 434. In one embodiment of the invention Integration module 422 communicates with home network 404 which is in communication with wireless module 402. In this way, for example, the operation of fan 318 as shown in FIG. 3 may be coordinated with the operation of the home control system 424. A previous example was coordination of an attic fan operation with a whole house fan operation.

While FIG. 4 shows various embodiments with, for example, a ceiling fan 430, the invention is not so limited and one or more of each of the various components and/or modules may be used in various embodiments. For example two or more ceiling fans or whole house fans may be used and/or controlled.

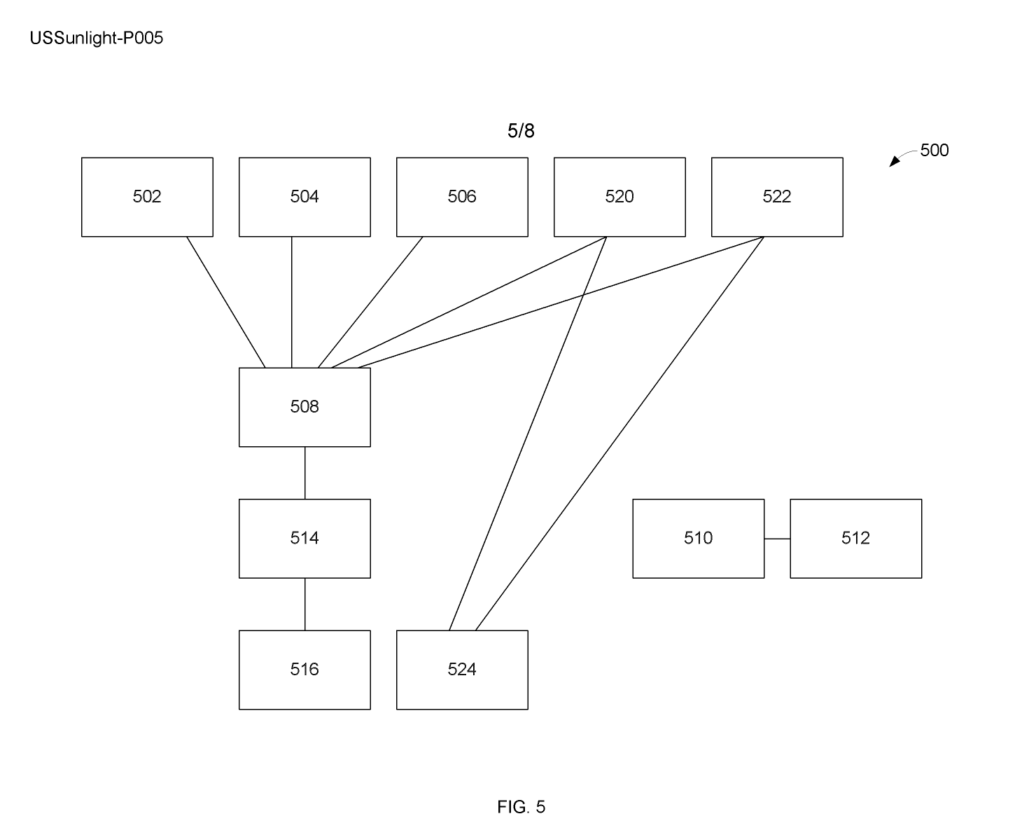

FIG. 5 illustrates, generally at 500, various embodiments of the invention. At 502 is sensing an attic temperature, at 504 is sensing an attic humidity, at 506 is sensing a fan status, at 508 is interfacing to a wireless module 514, the wireless module 514 for communicating to a home network 510 having Internet access 512. At 516 is reporting a status through the wireless module 514. This status can be one or more of the attic temperature, the attic humidity, and the fan status.

FIG. 5 illustrates, generally at 500, various embodiments of the invention. In one embodiment of the invention, the solar fan controller (SFC) senses a pressure 520 which can be one or more of an attic pressure, a home interior pressure, and an outside air pressure.

FIG. 5 illustrates, generally at 500, various embodiments of the invention. In one embodiment of the invention the presence of smoke is sensed 522.

FIG. 5 illustrates, generally at 500, various embodiments of the invention. In one embodiment of the invention, the solar fan controller (SFC) lowers the speed of the attic fan 524 when the attic pressure (one at 520) is less than a home interior pressure (one at 520).

FIG. 5 illustrates, generally at 500, various embodiments of the invention. In one embodiment of the invention, the solar fan controller (SFC) lowers the speed of the attic fan 524 by one half. In another embodiment the attic fan 524 is turned off.

FIG. 5 illustrates, generally at 500, various embodiments of the invention. In one embodiment of the invention, the solar fan controller (SFC) turns off the 524 attic fan when the presence of smoke is sensed at 522. In one embodiment of the invention the smoke may be sensed in an attic, a home interior, outside a home, be a signal from said home network (e.g. FIG. 4 at 404), or any combination of these.

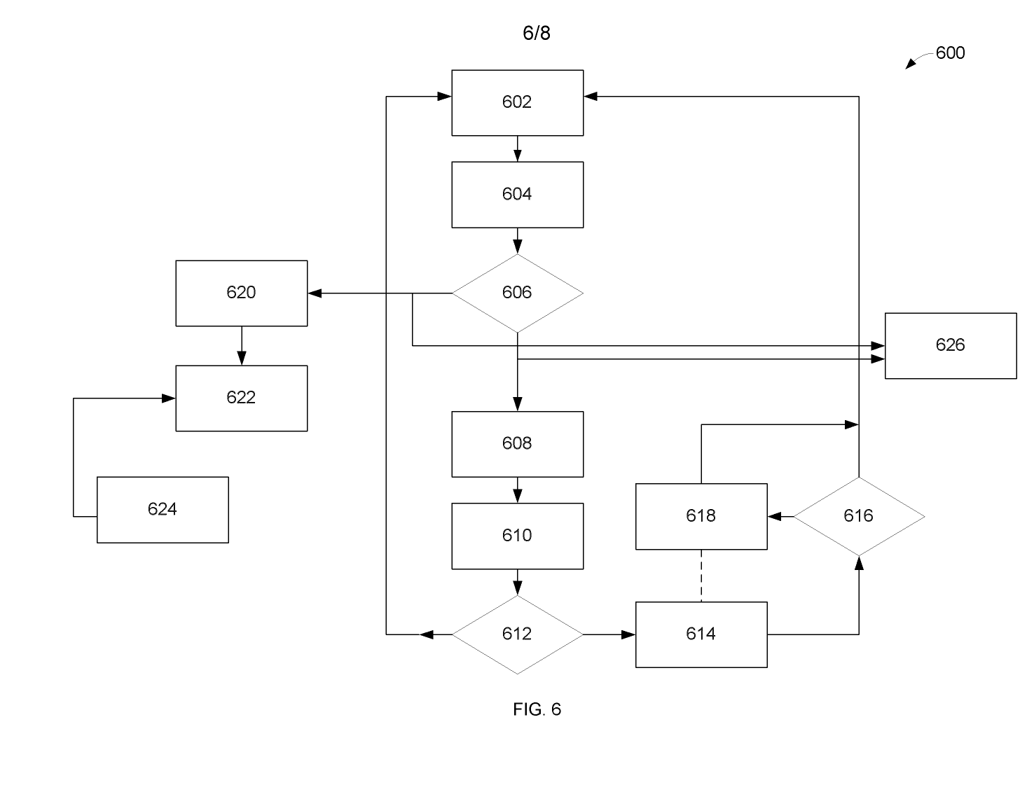

FIG. 6 illustrates, generally at 600, various embodiments of the invention. In one embodiment at 602 attic air pressure of a home is measured, at 604 the interior air pressure of a home is measured, at 606 is determining (sensing) sensing when a whole house fan in the home is operating and when it is we proceed to 608 and optionally 626. When it is not we proceed to 620 and optionally 626. At 608 we compare the attic air pressure and the interior home air pressure and generate a difference, at 610 optionally hysteresis may be introduced. At 612 we determine if a preset pressure between the measured interior air pressure of the home and the measured attic air pressure of the home is met (with optional hysteresis). If the preset is met then we continue at 602. If the present is not met then at 614 adjustments can be made to increase/decrease the speed of the attic fan and/or the whole house fan. Then we continue to 616 which is optional and if not used, then 616 and 618 are not used and 614 continues at 602. If optional 616 is implemented, then at 616 we determine if additional power is needed for the attic fan, if not then proceed to 602. If additional power is needed for the attic fan (e.g. cloudy, night, etc.) then at 618 power is provided to the attic fan (shown by dashed line) for adjustment at 614 and operation continues at 602.

FIG. 6 illustrates, generally at 600, various embodiments of the invention. In one embodiment at 602 attic air pressure of a home is measured, at 604 the interior air pressure of a home is measured, at 606 is determining (sensing) sensing when a whole house fan in the home is operating and when it is we proceed optionally (or also) to 626 where when the whole house fan is operating a solar panel is oriented to receive maximum power from the sun during the day and the solar panel is repositioned to a preset position before sunrise.

FIG. 6 illustrates, generally at 600, various embodiments of the invention. In one embodiment at 602 attic air pressure of a home is measured, at 604 the interior air pressure of a home is measured, at 606 is determining (sensing) sensing when a whole house fan in the home is not operating and when it is not operating we proceed optionally (or also) to 626 where when the whole house fan is not operating a solar panel is oriented to receive maximum power from the sun during the day and the solar panel is repositioned to a preset position before sunrise.

FIG. 6 illustrates, generally at 600, various embodiments of the invention. In one embodiment at 602 attic air pressure of a home is measured, at 604 the interior air pressure of a home is measured, at 606 is determining (sensing) sensing when a whole house fan in the home is not operating and when it is not operating we proceed to 620 where a weather forecast from an Internet connection is received and then the attic fan 622 is controlled based on the received weather forecast. In one embodiment the attic fan 622 is also controlled based on receiving inputs from the home indicating a desired temperature for an interior of the home. In one embodiment the fan may be controlled based solely on a desired temperature for an interior of the home without any other inputs. In one embodiment the fan may be controlled based solely on a received weather forecast. Thus in one embodiment the fan may be controlled based on both a desired temperature for an interior of the home and a received weather forecast.

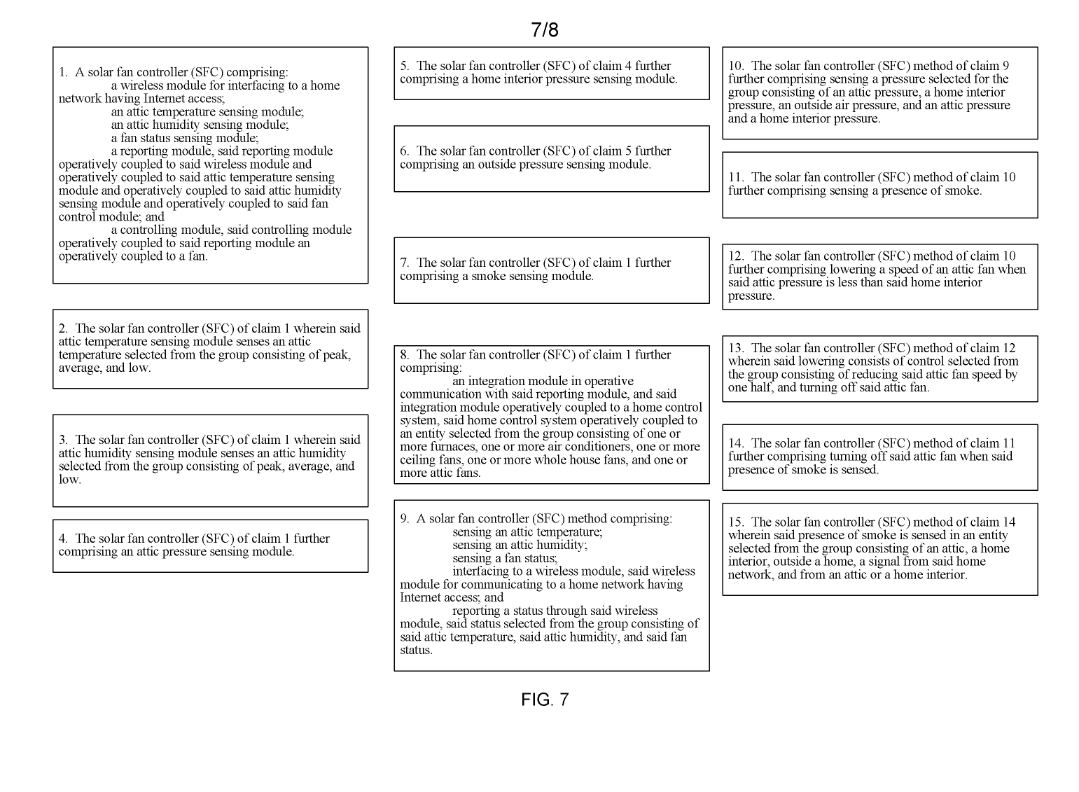

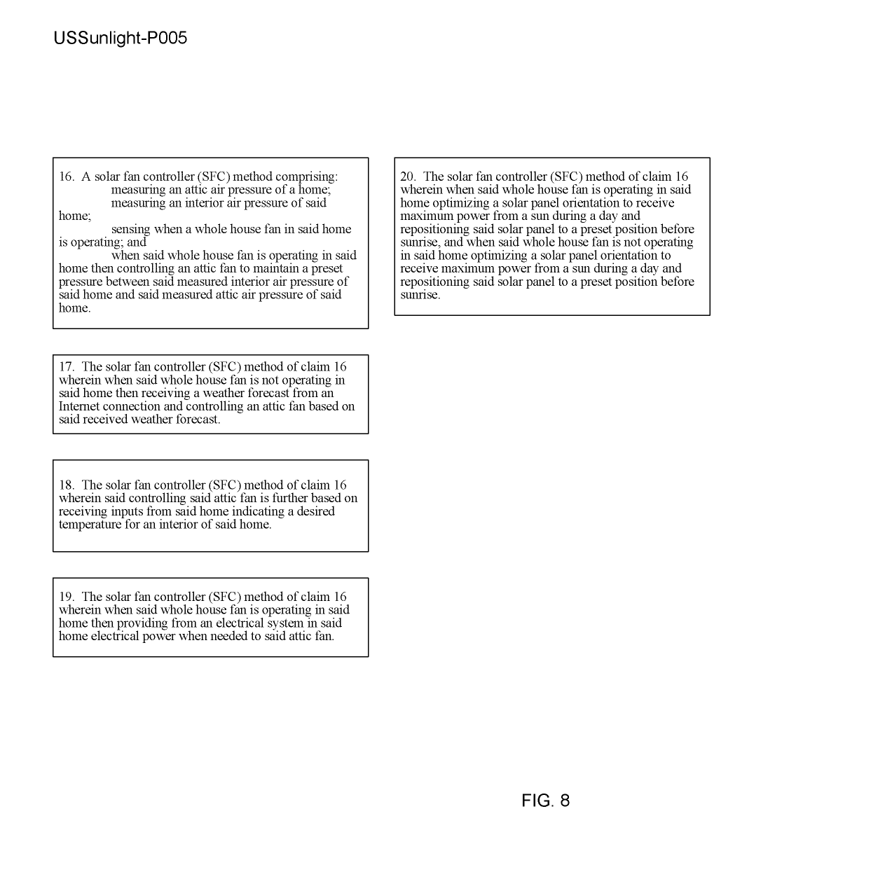

FIGS. 7 and 8 illustrate various embodiments of the invention as indicated below.

Illustrated generally at 1. A solar fan controller (SFC) comprising: a wireless module for interfacing to a home network having Internet access; an attic temperature sensing module; an attic humidity sensing module; a fan status sensing module; a reporting module, said reporting module operatively coupled to said wireless module and operatively coupled to said attic temperature sensing module and operatively coupled to said attic humidity sensing module and operatively coupled to said fan control module; and a controlling module, said controlling module operatively coupled to said reporting module an operatively coupled to a fan.

Illustrated generally at 2. The solar fan controller (SFC) of claim 1 wherein said attic temperature sensing module senses an attic temperature selected from the group consisting of peak, average, and low.

Illustrated generally at 3. The solar fan controller (SFC) of claim 1 wherein said attic humidity sensing module senses an attic humidity selected from the group consisting of peak, average, and low.

Illustrated generally at 4. The solar fan controller (SFC) of claim 1 further comprising an attic pressure sensing module.

Illustrated generally at 5. The solar fan controller (SFC) of claim 4 further comprising a home interior pressure sensing module.

Illustrated generally at 6. The solar fan controller (SFC) of claim 5 further comprising an outside pressure sensing module.

Illustrated generally at 7. The solar fan controller (SFC) of claim 1 further comprising a smoke sensing module.

Illustrated generally at 8. The solar fan controller (SFC) of claim 1 further comprising:

an integration module in operative communication with said reporting module, and said integration module operatively coupled to a home control system, said home control system operatively coupled to an entity selected from the group consisting of one or more furnaces, one or more air conditioners, one or more ceiling fans, one or more whole house fans, and one or more attic fans.

Illustrated generally at 9. A solar fan controller (SFC) method comprising: sensing an attic temperature; sensing an attic humidity; sensing a fan status; interfacing to a wireless module, said wireless module for communicating to a home network having Internet access; and reporting a status through said wireless module, said status selected from the group consisting of said attic temperature, said attic humidity, and said fan status.

Illustrated generally at 10. The solar fan controller (SFC) method of claim 9 further comprising sensing a pressure selected for the group consisting of an attic pressure, a home interior pressure, an outside air pressure, and an attic pressure and a home interior pressure.

Illustrated generally at 11. The solar fan controller (SFC) method of claim 10 further comprising sensing a presence of smoke.

Illustrated generally at 12. The solar fan controller (SFC) method of claim 10 further comprising lowering a speed of an attic fan when said attic pressure is less than said home interior pressure.

Illustrated generally at 13. The solar fan controller (SFC) method of claim 12 wherein said lowering consists of control selected from the group consisting of reducing said attic fan speed by one half, and turning off said attic fan.

Illustrated generally at 14. The solar fan controller (SFC) method of claim 11 further comprising turning off said attic fan when said presence of smoke is sensed.

Illustrated generally at 15. The solar fan controller (SFC) method of claim 14 wherein said presence of smoke is sensed in an entity selected from the group consisting of an attic, a home interior, outside a home, a signal from said home network, and from an attic or a home interior.

Illustrated generally at 16. A solar fan controller (SFC) method comprising:

measuring an attic air pressure of a home; measuring an interior air pressure of said home; sensing when a whole house fan in said home is operating; and when said whole house fan is operating in said home then controlling an attic fan to maintain a preset pressure between said measured interior air pressure of said home and said measured attic air pressure of said home.

Illustrated generally at 17. The solar fan controller (SFC) method of claim 16 wherein when said whole house fan is not operating in said home then receiving a weather forecast from an Internet connection and controlling an attic fan based on said received weather forecast.

Illustrated generally at 18. The solar fan controller (SFC) method of claim 16 wherein said controlling said attic fan is further based on receiving inputs from said home indicating a desired temperature for an interior of said home.

Illustrated generally at 19. The solar fan controller (SFC) method of claim 16 wherein when said whole house fan is operating in said home then providing from an electrical system in said home electrical power when needed to said attic fan.

Illustrated generally at 20. The solar fan controller (SFC) method of claim 16 wherein when said whole house fan is operating in said home optimizing a solar panel orientation to receive maximum power from a sun during a day and repositioning said solar panel to a preset position before sunrise, and when said whole house fan is not operating in said home optimizing a solar panel orientation to receive maximum power from a sun during a day and repositioning said solar panel to a preset position before sunrise.

One of skill in the art will appreciate that specific details on implementation are not germane to the techniques disclosed. For example, one of skill in the art understands that a fan controller may be implemented in a variety of ways, for example, but not limited to bang-bang, proportional plus derivative, pulse width modulation, pulse position modulation, amplitude modulation, etc. Likewise a wireless module may make use of, but is not limited to, radio frequency, infrared, WiFi, WiMax, laser, etc. A home network may have Internet access via, but is not limited to, cable modem, microwave, WiMax, asymmetric digital subscriber line, etc. Temperature may be sensed by, but is not limited to, a diode, a thermistor, resistance temperature detectors, etc. Humidity may be sensed by, but is not limited to capacitive, resistive, thermal conductivity, etc. A fan status may be sensed by, but is not limited to, optoelectronic, optical, current sensing, voltage sensing, back electromotive force, heat, etc. A solar fan controller (which includes, but is not limited to, a reporting module, a controlling module, etc.) uses specialized hardware as described infra. For example, one of skill in the art understands that coupled and operatively coupled may be implemented in a variety of ways, for example, but not limited to wire, wireless, optical, electrical, and any non-transitory mechanism. Likewise peak, average, and low measurements are understood by one of skill in the art and may be implemented, but are not limited to, mechanical, electrical, and look-up readings, etc. Pressure may be sensed by, but is not limited to capacitive, resistive, bourdon tube, etc. Smoke may be sensed by, but is not limited to capacitive, ionization, camera, infrared detector, optical, forward looking infrared, etc. For example, one of skill in the art understands that a signal from a home network may be implemented in a variety of ways, for example, but not limited to wired, wireless, etc. For example, one of skill in the art understands that a weather forecast may be implemented in a variety of ways, for example, data, instructions, and other non-transitory medium. For example, one of skill in the art understands that a desired temperature for an interior of a home may be indicated as a temperature setting, a differential, data, etc.

Thus a method and apparatus for solar fan controller (SFC) have been described.

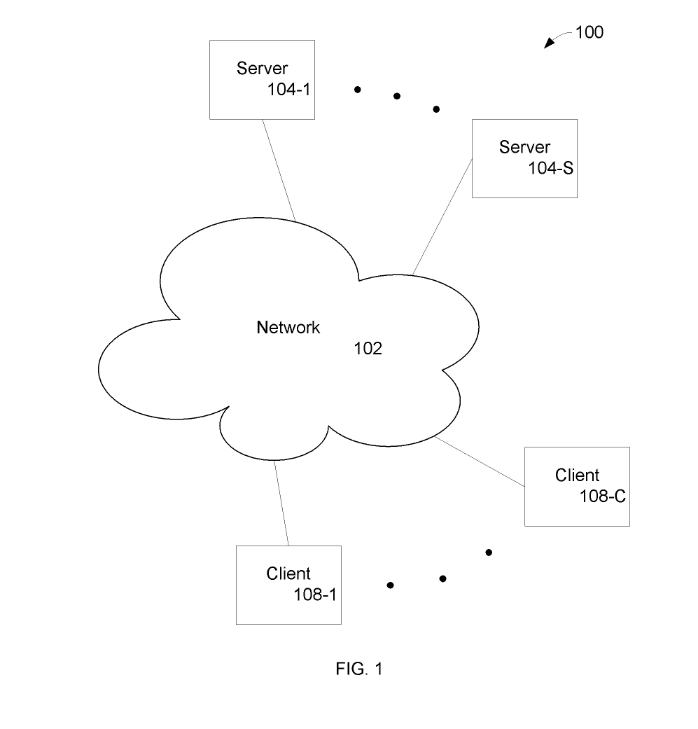

FIG. 1 illustrates a network environment 100 from which the techniques described may be accessed and/or controlled. The network environment 100 has a network 102 that connects S servers 104-1 through 104-S, and C clients 108-1 through 108-C. More details are described below.

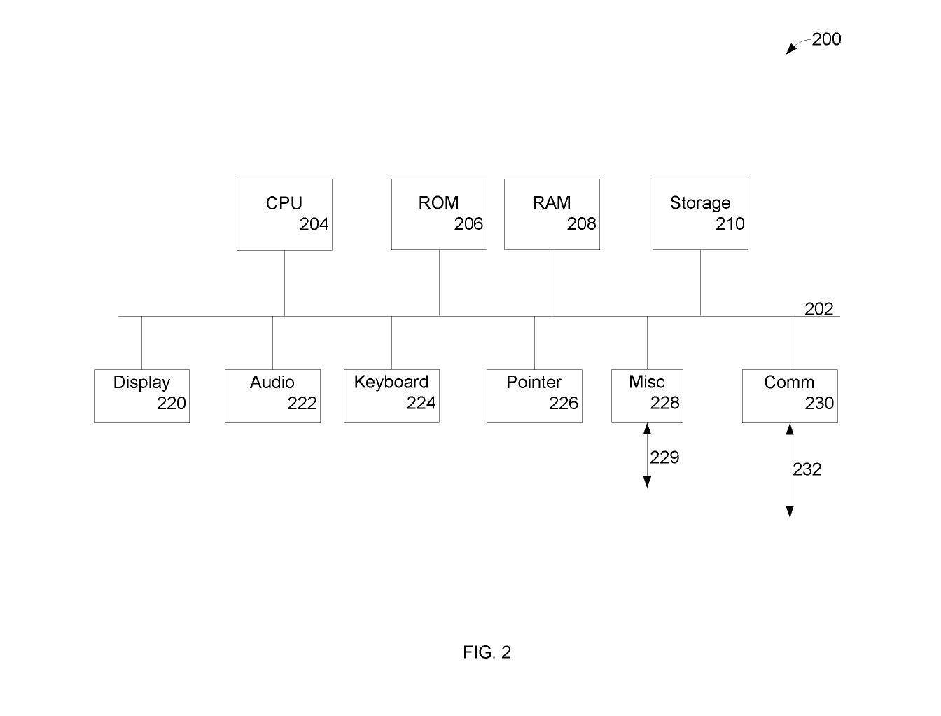

FIG. 2 is a block diagram of a computer system 200 which some embodiments of the invention may employ parts of in conjunction with required specialized hardware and which may be representative of use in any of the clients and/or servers shown in FIG. 1, as well as, devices, clients, and servers in other Figures. More details are described below.

Referring back to FIG. 1, FIG. 1 illustrates a network environment 100 in which the techniques described may be accessed and/or controlled. The network environment 100 has a network 102 that connects S servers 104-1 through 104-S, and C clients 108-1 through 108-C. As shown, several computer systems in the form of S servers 104-1 through 104-S and C clients 108-1 through 108-C are connected to each other via a network 102, which may be, for example, a corporate based network. Note that alternatively the network 102 might be or include one or more of: the Internet, a Local Area Network (LAN), Wide Area Network (WAN), satellite link, fiber network, cable network, or a combination of these and/or others. The servers may represent, for example, disk storage systems alone or storage and computing resources. Likewise, the clients may have computing, storage, and viewing capabilities. The method and apparatus described herein may be accessed and/or controlled by essentially any type of communicating means or device whether local or remote, such as a LAN, a WAN, a system bus, etc. For example, a network connection which communicates via for example wireless may control an embodiment of the invention having a wireless communications device. Thus, the invention may find application at both the S servers 104-1 through 104-S, and C clients 108-1 through 108-C.

Referring back to FIG. 2, FIG. 2 illustrates a computer system 200 in block diagram form, which may be representative of any of the clients and/or servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220, audio, 222, keyboard 224, pointer 226, miscellaneous input/output (I/O) devices 228 via link 229, and communications 230 via port 232. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 204 may be a single, multiple, or even a distributed computing resource. Storage 210, may be Compact Disc (CD), Digital Versatile Disk (DVD), hard disks (HD), optical disks, tape, flash, memory sticks, video recorders, etc., all non-transitory medium. Display 220 might be, for example, used by an embodiment of the present invention. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate non-transitory physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a non-transitory computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of non-transitory media suitable for storing electronic instructions either local to the computer or remote to the computer.

The techniques presented herein are specifically related to particular computer or other apparatus. A specialized apparatus to perform the required methods is required. For example, any of the methods according to the present invention can be implemented in hard-wired circuitry specifically designed for the functionality disclosed, or by programming special hardware having, for example, in one embodiment, a particular machine such as a computer (or CPU) specifically designed with a 4 bit or greater barrel shift register and a carry look ahead arithmetic logic unit. As disclosed Applicant submits that any results are tied to a particular machine or apparatus and/or transform a particular article into a different state or thing and that such particulars and/or things are non-trivial. For example, in FIG. 2 at 220 is a display. The results of the specialized machine may return an electronic value and such a value can be stored in hardware on the specialized machine and transformed into a graphical representation that can be displayed to a user of the computer. For example, in one embodiment, the returned value may be stored as a group of physical electrons on a trapped gate of a flash memory device. These physical electrons may then be transformed into a graphical representation, for example, by twisting the molecules of a liquid crystal display so that a carrier signal can be modulated and produces on reception a molecular change in a rod and cone receptor of a human user to produce physical electrons thus producing a tangible useful result and transformation tied to a particular machine such as a computer specifically designed with a 4 bit or greater barrel shift register and a carry look ahead arithmetic logic unit. For example the specialized hardware is required for logical operations and comparisons of values. For example, in one embodiment, the returned value may be stored as a series of holes on a paper tape that may be read by a person (e.g. a blind person) by tactile sensation (e.g. output from a KSR-33 Teletype). As disclosed Applicant submits that these results are tied to a particular machine or apparatus and/or transform a particular article into a different state or thing and that such particulars and/or things are non-trivial and as such satisfy Bilski.

The methods of the invention may be implemented using computer software on the specialized hardware as noted supra. If written in a programming language conforming to a recognized standard, sequences of instructions designed to implement the methods can be compiled for execution on the specialized hardware. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action and produce a tangible concrete non-transitory result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a specialized computer system in which the techniques of the present invention may be practiced as well as implemented as an embodiment).

A machine-readable medium is understood to include any non-transitory mechanism for storing or transmitting information in a form readable by a machine (e.g., a computer). For example, a non-transitory machine-readable medium includes read only memory (ROM); random access memory (RAM); magnetic disk storage media; optical storage media; flash memory devices; devices having non-transitory storage.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does one “embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

As used in this description, “substantially” or “substantially equal” or similar phrases are used to indicate that the items are very close or similar. Since two physical entities can never be exactly equal, a phrase such as ““substantially equal” is used to indicate that they are for all practical purposes equal.

It is to be understood that in any one or more embodiments of the invention where alternative approaches or techniques are discussed that any and all such combinations as may be possible are hereby disclosed. For example, if there are five techniques discussed that are all possible, then denoting each technique as follows: A, B, C, D, E, each technique may be either present or not present with every other technique, thus yielding 2̂5 or 32 combinations, in binary order ranging from not A and not B and not C and not D and not E to A and B and C and D and E. Applicant(s) hereby claims all such possible combinations. Applicant(s) hereby submit that the foregoing combinations comply with applicable EP (European Patent) standards. No preference is given any combination.

Thus a method and apparatus for solar fan controller (SFC) have been described.

What is claimed is:

1. A solar fan controller (SFC) comprising:
a wireless module for interfacing to a home network having Internet access;
an attic temperature sensing module;
an attic humidity sensing module;
a fan status sensing module;
a reporting module, said reporting module operatively coupled to said wireless module and operatively coupled to said attic temperature sensing module and operatively coupled to said attic humidity sensing module and operatively coupled to said fan control module; and
a controlling module, said controlling module operatively coupled to said reporting module an operatively coupled to a fan.

2. The solar fan controller (SFC) of claim 1 wherein said attic temperature sensing module senses an attic temperature selected from the group consisting of peak, average, and low.

3. The solar fan controller (SFC) of claim 1 wherein said attic humidity sensing module senses an attic humidity selected from the group consisting of peak, average, and low.

4. The solar fan controller (SFC) of claim 1 further comprising an attic pressure sensing module.

5. The solar fan controller (SFC) of claim 4 further comprising a home interior pressure sensing module.

6. The solar fan controller (SFC) of claim 5 further comprising an outside pressure sensing module.

7. The solar fan controller (SFC) of claim 1 further comprising a smoke sensing module.

8. The solar fan controller (SFC) of claim 1 further comprising:
an integration module in operative communication with said reporting module, and said integration module operatively coupled to a home control system, said home control system operatively coupled to an entity selected from the group consisting of one or more furnaces, one or more air conditioners, one or more ceiling fans, one or more whole house fans, and one or more attic fans.

9. A solar fan controller (SFC) method comprising:
sensing an attic temperature;
sensing an attic humidity;
sensing a fan status;
interfacing to a wireless module, said wireless module for communicating to a home network having Internet access; and
reporting a status through said wireless module, said status selected from the group consisting of said attic temperature, said attic humidity, and said fan status.

10. The solar fan controller (SFC) method of claim 9 further comprising sensing a pressure selected for the group consisting of an attic pressure, a home interior pressure, an outside air pressure, and an attic pressure and a home interior pressure.

11. The solar fan controller (SFC) method of claim 10 further comprising sensing a presence of smoke.

12. The solar fan controller (SFC) method of claim 10 further comprising lowering a speed of an attic fan when said attic pressure is less than said home interior pressure.

13. The solar fan controller (SFC) method of claim 12 wherein said lowering consists of control selected from the group consisting of reducing said attic fan speed by one half, and turning off said attic fan.

14. The solar fan controller (SFC) method of claim 11 further comprising turning off said attic fan when said presence of smoke is sensed.

15. The solar fan controller (SFC) method of claim 14 wherein said presence of smoke is sensed in an entity selected from the group consisting of an attic, a home interior, outside a home, a signal from said home network, and from an attic or a home interior.

16. A solar fan controller (SFC) method comprising:
measuring an attic air pressure of a home;
measuring an interior air pressure of said home;
sensing when a whole house fan in said home is operating; and
when said whole house fan is operating in said home then controlling an attic fan to maintain a preset pressure between said measured interior air pressure of said home and said measured attic air pressure of said home.

17. The solar fan controller (SFC) method of claim 16 wherein when said whole house fan is not operating in said home then receiving a weather forecast from an Internet connection and controlling an attic fan based on said received weather forecast.

18. The solar fan controller (SFC) method of claim 16 wherein said controlling said attic fan is further based on receiving inputs from said home indicating a desired temperature for an interior of said home.

19. The solar fan controller (SFC) method of claim 16 wherein when said whole house fan is operating in said home then providing from an electrical system in said home electrical power when needed to said attic fan.

20. The solar fan controller (SFC) method of claim 16 wherein when said whole house fan is operating in said home optimizing a solar panel orientation to receive maximum power from a sun during a day and repositioning said solar panel to a preset position before sunrise, and when said whole house fan is not operating in said home optimizing a solar panel orientation to receive maximum power from a sun during a day and repositioning said solar panel to a preset position before sunrise.
